(19) United States
(12) Patent Application Publication
(10) Pub. No.: US 2009/0074956 A1
(43) Pub. Date: Mar. 19, 2009

(54) INKJET PRINTING OF MATERIALS FOR USE IN FUEL CELLS

(75) Inventor: Andre D. Taylor, New Haven, CT (US)

Correspondence Address: BROOKS KUSHMAN P.C., 1000 TOWN CENTER, TWENTY-SECOND FLOOR, SOUTHFIELD, MI, 48075, US

(73) Assignee: THE REGENTS OF UNIVERSITY OF MICHIGAN, Ann Arbor, MI (US)

(21) Appl. No.: 12/210,615

(22) Filed: Sep. 15, 2008

Related U.S. Application Data
(60) Provisional application No. 60/993,664, filed on Sep. 13, 2007.

(51) Int. Cl. B05D 5/12; B05C 5/02

(52) U.S. Cl. 427/115; 118/323

(57) ABSTRACT

A method of using inkjet printing (IJP) to deposit catalyst materials onto substrates such as gas diffusion layers (GDLs) that in one application are made into membrane electrode assemblies (MEAs) for polymer electrolyte fuel cells (PEMFC). The inventive IJP method can deposit smaller volumes of water-based catalyst ink solutions with picoliter precision. By optimizing the dispersion of the ink solution, this technique can be used with catalysts supported on different specimens of carbon black.

### CROSS-REFERENCE TO RELATED APPLICATIONS

This application claims the benefit of U.S. provisional application Ser. No. 60/993,664 filed Sep. 13, 2007, which is incorporated herein by reference.

### BACKGROUND OF THE INVENTION

1. Field of the Invention

The invention relates to the printing of catalyst material intended primarily but not exclusively for use in fuel cells by inkjet printing methods.

2. Background Art

Polymer electrolyte membrane fuel cells (PEMFC's) are rapidly gaining attention as alternatives to current power sources due to their high efficiencies and ability to operate without greenhouse gas emissions. It is known that carbon supported platinum nanoparticles (Pt/C) as well as various platinum alloys on carbon are sometimes used as electrocatalysts in polymer electrolyte membrane fuel cells (PEMFC). They catalyze the anodic oxidation of oxygen and the cathodic reduction of oxygen. It is also known that the type of the support can influence the activity of the catalyst. Many PEMFC's use Pt/C electrode catalyst layers.

There are several traditional methods of applying Pt/C electrolyte catalyst layers. Screen printing (similar to brush painting) is a simple and cost effective process involving no apparatus other than a membrane holder (CCM) or paint brush with minimal waste. Yet these techniques have several disadvantages.

First, the uniformity of catalyst deposited on the electrode is not easily controlled and can vary depending on the person depositing the catalyst material. Second, these processes can be time consuming, requiring iterations of painting, drying, and massing to achieve the desired loading of catalyst. Iterations of the weighing and painting steps, in addition to solvent evaporation or changes in mass uptake of the brush can contribute to poor reproducibility. Spray painting overcomes many of the problems associated with brush painting and allows for a more uniform distribution of catalyst material. It also opens the doors to automation for large scale production; however, a considerable amount of catalyst is often wasted in the feed lines due to periodic clogging which could increase the cost of production.

Ink jet printing (IJP) has emerged as one of the most popular forms of data imaging for home and small office applications and is quickly gaining recognition in a variety of other fields. IJP places tiny droplets of ink solution onto a substrate without dependence on the high-speed operation of mechanical printing elements. Because IJP methods are additive (reducing waste and processing steps), they have been evaluated for several multilayer devices including organic transistors, 3-D MEMs, biopolymer arrays, and photonic crystal microarrays. However, existing ink deposition methods such as spray painting or screen printing are not well suited for ultra low (<<0.5 mg Pt cm⁻²) loadings.

To produce smooth printings, the ink properties should be taken into account. For example, the ink viscosity must be low enough for each nozzle to expel a droplet of ink. In addition, the size of the particles (usually less than a few hundred nanometers in diameter) and dispersion of the particles should be controlled to prevent clogging of the print nozzles. The ink solution should also have a surface tension large enough to prevent ink from leaking from the nozzles. For fuel cell applications, the controlled blending and deposition of the Pt/C electrolyte catalyst solutions could have a significant impact on the utilization of Pt. It would be desirable to optimize utilization, for example, by allowing the Pt to have simultaneous access to the gas, the electron conducting medium, and the proton conducting medium. These interfacial areas, called triple-phase boundaries (gas-electrolyte-electrode), are essential for optimal fuel cell performance.

In polymer electrolyte membrane fuel cells (PEMFCs), Nafion® is used as a membrane placed between the anode and the cathode, but also as a component of an active layer in a gas diffusion electrode. The content of Nafion® ionomer in the electrode affects the catalytic activity.

One of the obstacles preventing the commercialization of fuel cells is the utilization of noble metals, most often platinum (Pt) or platinum-based alloys, to catalyze the oxidation and reduction reactions. Methods for producing Pt nanoparticles supported on carbon have helped to lower Pt loadings in PEMFCs. Although research has reduced catalyst loading levels down from 4 to below 0.4 mg Pt cm⁻², the Pt utilization of typical commercially offered prototype fuel cells remains low (20-30%).

Thin film deposition such as sputtering has been investigated for catalyst deposition at ultra low loadings. While this method could allow for large scale production, the expenditure is still substantial due to costs associated with clean rooms, Pt targets, and ultra high vacuum equipment. In addition, the Pt deposited is often unsupported and the electrolyte cannot be deposited simultaneously with the Pt limiting the catalyst layer to only two dimensions.

### SUMMARY OF THE INVENTION

One aspect of the invention relates to a method of using inkjet printing (IJP) to deposit catalyst materials onto gas diffusion layers (GDLs) or polyelectrolyte membranes that are made into membrane electrode assemblies (MEAs) for a polymer electrolyte fuel cell (PEMFC).

The IJP method can be used to deposit smaller volumes of water-based catalyst ink solutions with picoliter precision, provided the solution properties are compatible with the cartridge design.

By optimizing the dispersion of the ink solution, this technique can be used with catalysts supported on different carbon black (e.g., XC-72R, Monarch 700, Black Pearls 2000) as well as other materials.

Using the inventive approach disclosed herein, ink jet printed MEAs with catalyst loadings of 0.020 mg Pt cm⁻² have produced Pt utilizations in excess of 16,000 mW mg⁻¹ Pt which is higher than traditional screen printed MEAs (800 mW mg⁻¹, Pt).

For fuel cell applications, the inventive IJP technology resolves many of the problems associated with previous methods of catalyst deposition by allowing a uniform distribution of catalyst material onto the surface of the GDL (CCE) or electrolyte CCM (i.e. CCE or CCM catalyst coated electrodes or membranes). With a fixed nozzle volume, each printing delivers precise picoliter control of deposition, which is useful for creating membrane electrode assemblies (MEA) with ultra low (e.g., <0.05 mg Pt cm⁻²) loadings.

Inkjet printing (IJP) has thus been demonstrated as a catalyst application method for PEMFCs. The resulting anodes gave comparable, if not better performance than those fabricated using conventional screen printing or hand painting methods. The high precision of IJP allows for controlled catalyst deposition, especially for ultra low platinum (Pt) loadings. These low loadings, which are not easily attained using conventional methods, give some of the highest Pt utilizations reported in the prior art.

In one aspect, therefore, the invention includes a method of using IJP to deposit 3-D catalyst layer materials. In some applications, the materials can be used in PEMFC's.

### BRIEF DESCRIPTION OF THE DRAWINGS

FIG. 1 compares conventional (hand printing) with the inventive steps of inkjet printing and illustrates the related time savings;

FIG. 2 depicts thermogravimetric analysis (TGA) curves for the oxidation of a Pt/C composite;

FIG. 3 illustrates printed catalyst layers using the inventive IJP method;

FIG. 4 is a graph of viscosity as a function of shear rate for standard catalysts and inkjet solutions;

FIG. 5 is an illustration of IJP versus brush painting, both with an anode loading of 0.51 mg Pt cm²;

FIG. 6 is a bar chart that illustrates Pt utilization against Pt loading, comparing catalysts prepared by inkjet and hand printing methods;

FIG. 7 is a performance comparison among various IJP Pt-supported carbons;

FIG. 8 illustrates a catalyst layer graded structure; and

FIG. 9 is a performance comparison of a standard uniform catalyst to a graded catalyst.

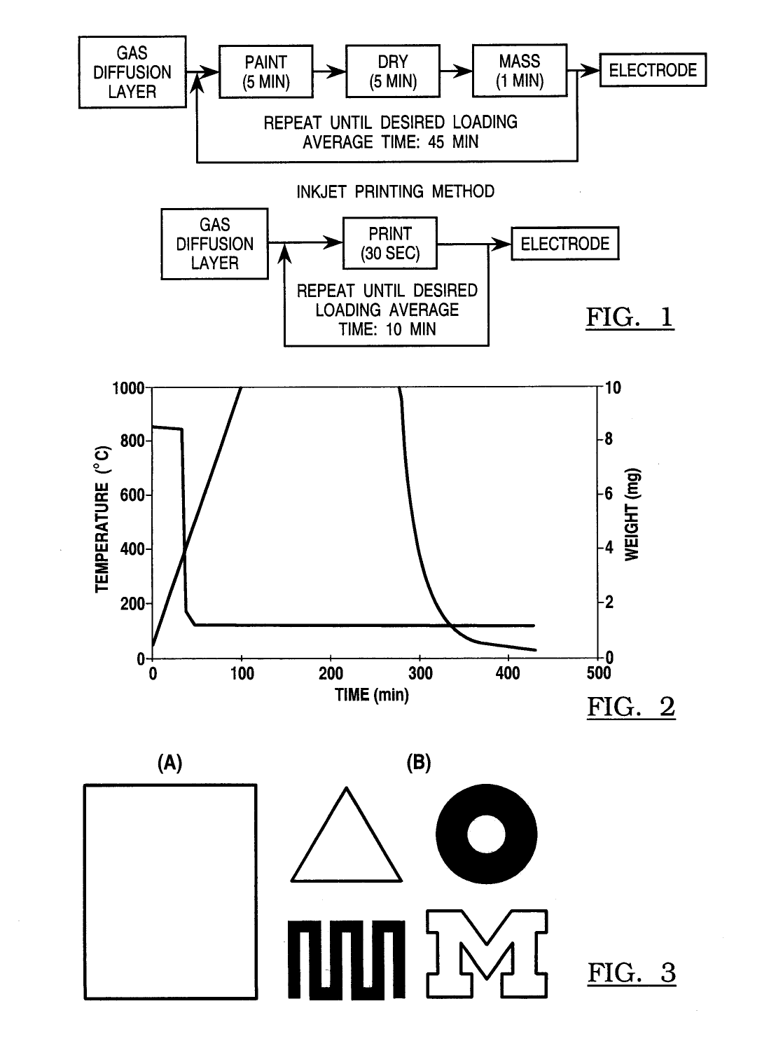

### DETAILED DESCRIPTION OF THE PREFERRED EMBODIMENT(S)

Conventional inkjet printing technology can reproducibly dispense small droplets of fluid onto a desired location upon a substrate. The present invention discloses a material flowing through a nozzle in an inkjet cartridge, the material including three main components: (1) a catalyst (for example, carbon powder); (2) a metal (such as platinum powder); and (3) a polyelectrolyte in solution form (e.g. Nafion® 117). These components are carried in a liquid solvent which ultimately disperses after the effluent is deposited on a substrate. As used herein, the term “catalyst ink material” is used to demote the effluent from the inkjet printer.

The present invention comprehends such substrates as gas diffusion layers, (e.g. carbon cloth or carbon paper), and a solid polyelectrolyte, such as but not limited to Nafion® 117.

What results is a deposit of a catalyst material that is delivered with picoliter precision that can be used, for example, to create membrane electrode assemblies (MEA's) with ultra-low (<0.05 mg Pt cm⁻²) loadings.

### 1. EXPERIMENTAL

### 1.1 Catalyst Preparation

The standard catalyst used in several experiments was a commercially available JM 20 wt % Pt on carbon black. Additional materials for the graded catalyst were JM10 and JM50 wt % Pt on carbon black. The flexibility of the inventive use of IJP technology facilitated the investigation of other carbon supports that are discussed later herein.

Although other materials may be used in the practice of this invention, the following carbon blacks were functionalized in super critical (SC) methanol using Pt (II) acetylacetonate as a precursor—Vulcan XC-72R (Cabot), Monarch 700 (Cabot), Black Pearls 2000 (Cabot), and an experimental carbon black RC2 (Sid-Richardson).

For Pt loading, a modified procedure similar to that used by Zhenyu et al. was followed. S. Zhenyu, F. Lei, L. Zhimin, M. Buxing, L. Yunqi, D. Jimin, J. Nanosci. Nanotechnol. 6 (2006) 691-697, which is incorporated herein by reference. The pellet form of the black Pearls 2000 was crushed to a fine powder, whereas the other carbon supports were used as received.

In one experiment, a 4.1 ml stainless steel reactor, 35.0 mg of carbon black, 17.6 mg of Pt (II) acetylacetonate, and 3.28 ml of methanol were combined. The contents were sealed and placed into a sand bath at 300° C. for 30 min. Under these conditions the MeOH became a supercritical fluid capable of reducing the Pt (II) acetylacetonate. The resulting Pt/C catalyst was dried overnight at room temperature. This procedure resulted in a nominal loading of 20 wt % Pt.

TGA Thermogravimetric Analyzer (Model SDT Q600 Instrument, TA Instruments, Inc.,) analysis was used to determine actual loadings of the prepared catalysts. K Cheng, M. H. Yang, W. W. W. Chiu, C. Y. Huang, J. Chang, T. F. Ying, Y Yang, Macromol. Rapid Comm. 26 (2005) 247-264, which is incorporated herein by reference. Experiments were conducted by ramping the sample temperature in air to 1000° C. Steep reductions in mass were observed around 420° C. where the carbon support was oxidized, leaving the Pt particles behind. At 1000° C., it was assumed that all the carbon support had been removed from the sample and only oxidized Pt particles remained as PtO. Actual catalyst loadings were then calculated based on the beginning mass of the Pt/C nanocomposite and ending mass of the remaining PtO particles. An example of a typical TGA curve is shown in FIG. 2.

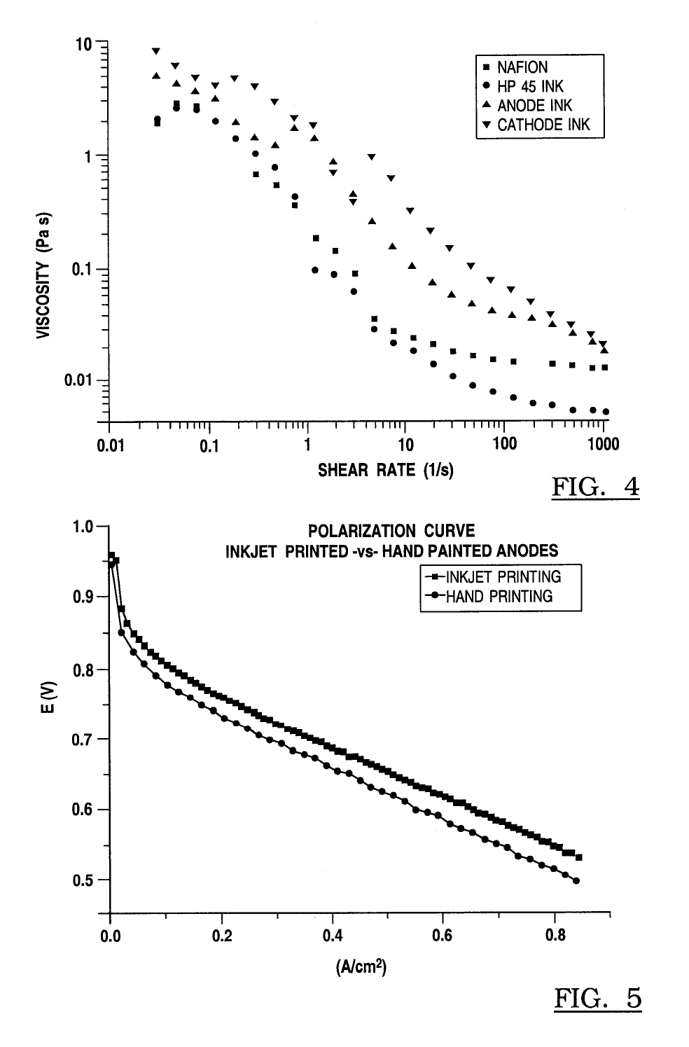

Although other materials may be used in the practice of this invention, inks for the anode catalyst layers were prepared with a ratio of 75 wt % of the Pt/C catalyst and 25 wt % Nafion® solution (Aldrich, 5 wt % in lower aliphatic alcohols and water) and dispersed in a suitable solvent mixture with viscosity comparable to HP ink (see FIG. 4). The typical cathode solution consisted of 50.3 mg catalyst (JM 20 wt % Pt), 382.9 μl Nafion® solution, and 3.0 ml of methanol. Inks were sonicated for 30 min then stirred with a micro stir bar for an additional 30 minutes.

For all the catalyst inks tested, there was no observable settling or agglomeration after several days of observation. For comparison, an anode was fabricated using a hand painting (HP) method, using the standard catalyst dispersed in a mixture of isopropyl alcohol and water. Inks for all cathodes were prepared with 63 wt % Pt/C, 25 wt % Nafion®, and 12% PTFE (Dupont) dispersed in a 50/50 mixture of isopropyl alcohol and water. The inks were applied by HP at a loading of 0.50 mg Pt cm⁻² for all cathodes.

### 1.2 Printer Setup

A commercially available thermal ink-jet printer (Lexmark Z32) was used in one set of experiments. The specifications report a maximum resolution of 1200 dpi×1200 dpi and a drop size of 28 pl (http://www.lexmark.com). Thermal inkjet printers are preferred over piezoelectric inkjet printers as they contain larger nozzle volumes, thereby reducing the chance for clogging. Standard black ink cartridges (e.g., Lexmark 17G0050) were used to print the catalyst inks, although practice of the invention is not so limited. After emptying, the cartridges were cleaned in a sonication bath for 30 minutes. The catalyst inks were then placed inside the ink well and the cartridge was loaded into the printer.

The Pt loading was calculated from the density of the ink, weight percent of Pt supported carbon, the printer resolution, and the volume of each droplet. The loadings were calculated assuming that none of the nozzles were clogged.

In one example, carbon cloth (Toray) was cut into 1″×1″ squares for use as gas diffusion layers (GDLs). The squares were attached to standard 8.5″×11″ white paper using double sided tape. A black square of catalyst ink was printed onto the GDL using the “best print quality” feature on the printer settings to achieve the best resolution the printer offered. To ensure that the catalyst ink was printing, a small square was printed elsewhere on the paper. The paper containing the GDL was then reloaded into the paper tray and the printing process was repeated until the desired loading was achieved.

FIG. 3a schematically illustrates the successful printing of catalyst onto a full 8.5″×11″ sheet of paper which could be scaled for larger industrial applications. FIG. 3b illustrates how catalyst deposition can be controlled to specific shapes and areas with for instance an enclosed structure, serpentine channels, and a block letter M. Successful qualitative printings were also performed directly onto Toray carbon paper as well as Nafion® 117.

### 1.3 MEA Preparation

Although other materials may be used in the practice of this invention, all gas diffusion layers (GDL's) used were from E-Tek (ELAT V3.1 double side automated). All electrodes fabricated by IJP or screen printing were placed in an oven for final bake out at 180° C. for 1 hour to dry any residual solvent.

Nafion® 117 (Ion Power) films were cleaned using the following procedure: to remove organic impurities and to obtain the H⁺ form for use in the PEMFC, the membranes were pretreated by boiling in 50 vol % HNO₃ and deionized water for 1 hour, rinsing in boiling deionized water for 30 minutes, boiling in 0.5 M H₂SO₄ solution for 30 minutes, and boiling twice in DI water for 30 minutes. The membranes were subsequently stored in DI water until ready for use.

The MEAs were made in one experiment, by hot pressing an anode, electrolyte membrane, and cathode in a heated press set at 135° C. for 5 minutes at a pressure of 10 MPa. The MEAs were conditioned overnight until a steady state current was achieved at a potential of 0.6V. The temperature of the fuel cell was 80° C. and the anode and cathode saturators were set at 90° C. (100% relative humidity). The flow rates of the humidified hydrogen and oxygen were set at 100 sccm.

### 2. Results and Discussion

### 2.1 Inkjet Printed Anode Using JM Catalysts

To confirm that the ink properties of the catalyst ink were suitable for use in IJP, viscosities of catalyst inks were compared to standard black printer ink (HP45) manufactured by Hewlett Packard. A constant stress rheometer (TA Instruments AR 1000) was used to measure the viscosity at a given shear rate.

As FIG. 4 shows, the viscosity of the standard anode and cathode inks follow a similar trend as the HP45 and Nafion® (5%) solution. At the highest shear rate, the viscosity of the HP45 ink was approximately an order of magnitude less than the anode, cathode, and Nafion® solution. The shear rate for the printer used is 1.4×10⁵ s⁻¹. Although the shear cell could only measure viscosities at a shear rate of 1000 s⁻¹, the results show that suitable dispersions containing the right compounds can be used for IJP.

Two anode catalyst layers were prepared from standard JM Pt/C (20 wt % Pt) using HP and IJP deposition methods. The loading for both electrodes was 0.51 mg Pt cm⁻² and both MEAs were tested in a fuel cell test station.

FIG. 5 shows the resulting polarization curves, comparing the performance of both catalyst layers. The HP MEA had a peak power density of 387 mW cm⁻² which is slightly less than the IJP MEA, which was 426 mW cm⁻². Based upon the loadings, catalyst utilizations for the HP and IJP were 774 and 852 mW mg⁻¹ Pt, respectively.

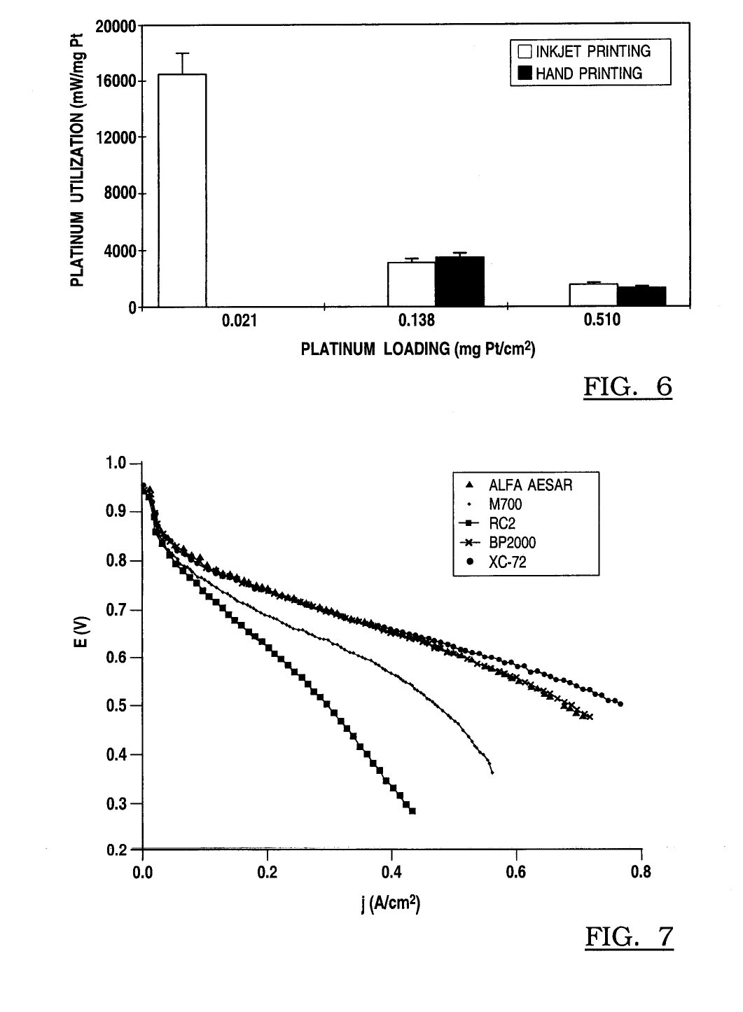

FIG. 6 illustrates how the Pt utilization changes as the loading of the catalyst layer decreases. At a loading of 0.138 mg Pt cm⁻² the HP method gave a slightly better Pt utilization with an average Pt utilization of 2500 mW mg⁻¹ Pt.

The clear advantage of IJP is shown at an ultra low catalyst loading of 0.021 mg Pt cm⁻². Using HP for such a low loading was not practical (using a standard catalyst solution), as achieving uniformity of catalyst deposition was very difficult, as was reaching the correct catalyst loading without over loading. The IJP technique at this loading gave a reproducible Pt utilization of 17,600 mW mg⁻¹ Pt. This is one of the highest values reported in the prior art.

The dispersion of this ink was made to give this final loading after four complete passes. Hence, it is conceivable that this ultra low loading can be reduced even lower. Without being bound by a particular theory, one possible explanation for the higher Pt utilizations at lower loadings is the higher probability of regions where catalyst, carbon support, and electrolyte come in contact. Known as the triple phase boundary, only the Pt that lies in this region can be utilized. As the thickness of the catalyst layer decreases, typical discontinuities in the catalyst region statistically diminish. This would leave a larger amount of Pt within the triple phase boundary available for reaction.

### 2.2 Inkjet Printed Anodes Using Carbon Catalysts

FIG. 7 illustrates results for carbon supported catalysts that were functionalized with Pt using SC MeOH and IJP as anode catalyst layers—XC-72 (Cabot), Monarch 700 (Cabot), RC2 (Sid-Richardson), Alfa Aesar, and Black Pearls 2000 (Cabot).

Table 1 lists the material properties of some typical carbon supports as reported in literature or by the supplier.

TABLE 1

| Carbon Support | Particle size (nm) | Surface area (m²g⁻¹) |
|---|---|---|
| Johnson Matthey (JM) | 30 | 254 |
| XC-72 | 30 | 254 |
| M700 | 18 | 200 |
| Ketjenblack | 36 | 1400 |
| RC2 | Pellets | 115 |
| Black Pearls 2000 | 12 | 1500 |

A range of Pt loadings (10-50 wt %) was used to illustrate the flexibility of IJP. Table 2 illustrates the loading and Pt utilizations of the various supports in comparison to the JM (Alfa Aesar) standard catalyst.

TABLE 2

| | Pt Wt % of | Loading (mg Pt | Pt utilization |
|---|---|---|---|
| Catalyst | Catalyst | cm⁻² of electrode) | (mW mg⁻¹ Pt) |
| JM | 20 | 0.121 | 2608 |
| M700 | 35 | 0.073 | 3017 |
| RC2 | 11.7 | 0.07 | 1990 |
| BP2000 | 15.4 | 0.093 | 3418 |
| SC-72 | 47 | 0.133 | 2673 |

Thus, IJP can be used to deposit a variety of different carbon supports with different material properties (i.e. particle size, surface area, conductivity, etc.). From these initial results, it appears that BP 2000 is a promising support.

### 2.3 Graded Catalyst Deposition

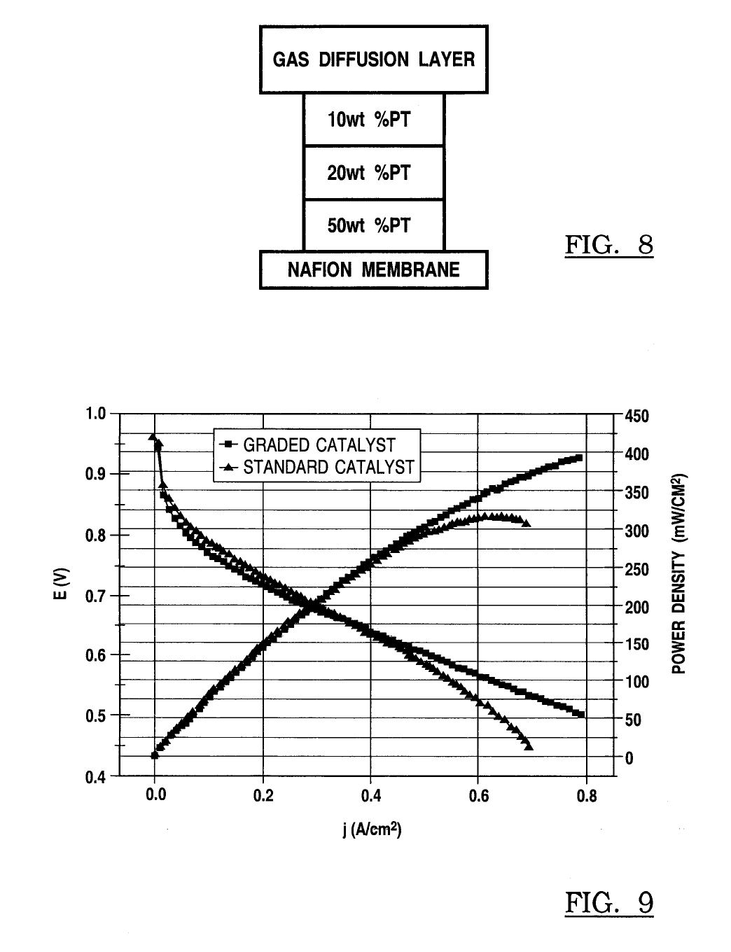

Previous research on thin film catalysts suggests that Pt is better utilized when it is concentrated near either the electrode catalyst layer or electrolyte catalyst layer interface. Using IJP, catalysts could be deposited of different Pt concentrations layer by layer, such that the region closest to the electrolyte membrane had the highest concentration of Pt, while the region furthest away had the lowest concentration, as shown in FIG. 8.

Standard JM catalysts (10, 20, and 50% Pt on carbon black) were used in one set of experiments. The uniform catalyst structure contained 20% Pt on carbon black.

As illustrated in FIG. 9, the graded catalyst structure performed better than the uniformly distributed catalyst at nearly the same overall Pt loading. Other gradients in the catalyst layer have been shown to improve performance.

Significantly increasing the Nafion® content of the catalyst layer using IJP is not a trivial task. Although the radius of gyration of Nafion® is significantly small compared to the nozzle opening, the presence of the polyelectrolyte in the dispersion can increase particle agglomeration.

Thus, inkjet printing has been shown as a viable method for applying a catalyst in the manufacture of PEMFC's. The resulting anodes gave comparable if not better performance than those fabricated using conventional screen printing or hand painting methods. The high precision of IJP allows for controlled catalyst deposition, especially for ultra low Pt loadings. These low loadings, which are not easily attained using conventional methods, give high Pt utilizations.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An inkjet print apparatus for printing an image by ejecting a material from a print head:
the material including a catalyst, a metallic powder, and a polyelectrolyte in solution form, the catalyst, the metallic powder, and the polyelectrolyte being transported in a solvent.

2. The apparatus of claim 1 wherein the catalyst, the metallic powder, and the polyelectrolyte and the solvent are intermixed with each other and lie upon a substrate.

3. The apparatus of claim 2 wherein the substrate is selected from the group consisting of a gas diffusion layer, carbon paper, and a solid polyelectrolyte.

4. The apparatus of claim 3 wherein the solid polyelectrolyte comprises Nafion®.

5. The apparatus of claim 4 wherein the solid polyelectrolyte comprises Nafion® 117.

6. A method of patterning, the method comprising:
providing a substrate;
depositing a droplet including a material with a catalyst, a metallic powder, and a polyelectrolyte in solution form, the catalyst, the metallic powder, and the polyelectrolyte being transported in a solvent; and
allowing the solvent deposited on the surface of the substrate to evaporate, thereby leaving an intermixed layer of catalyst and metallic powder remaining on the substrate.

7. The method of claim 6 further comprising the step of hot pressing the material upon the substrate, thereby facilitating evaporation of the catalyst and intermixing of the catalyst and metallic powder.

8. A method of using inkjet printing to deposit catalyst materials including a catalyst, a metallic powder, and a polyelectrolyte in solution form, the catalyst, the metallic powder, and the polyelectrolyte being transported in a solvent, onto gas diffusion layers for fabrication into membrane electrode assemblies deployed in polymer electrolyte fuel cells.

9. The method of claim 8 the resultant membrane electrode assembly is characterized by a Pt loading less than 0.05 mg Pt cm⁻².

10. The method of claim 8 wherein the catalyst comprises Pt and wherein the resultant membrane electrode assembly is characterized by a catalyst loading of about 0.020 mg Pt cm⁻² and Pt utilization in excess of 16,000 mgW mg⁻¹ Pt.

11. The method of claim 6 wherein the deposition step comprises selecting a catalyst from the group consisting of JM10, JM20, JM50 Wt % Pt on carbon black, Black Pearls 2000, M700, RC2, SC-72 and Ketjen.

12. The method of claim 6 wherein the anode catalyst layer comprises 75 Wt % of the Pt/C catalyst and 25 Wt % Nafion® solution that is dispersed with a solvent mixture.

13. The method of claim 12 further comprising the step of providing a catalyst loading of 0.021 mg Pt cm⁻² and a Pt utilization of 17,600 mWmg⁻¹ Pt.

14. The method of claim 13 further comprising the step of preparing a graded catalyst with a catalyst layer graded structure having a Nafion® membrane, a layer of 50 Wt % Pt, a layer of 20 Wt % Pt, a layer of 10 Wt % Pt, and a gas diffusion layer, so that the concentration of Pt decreases with distance from the Nafion® membrane.
